(19) United States
(12) Patent Application Publication
(10) Pub. No.: US 2011/0097680 A1
(43) Pub. Date: Apr. 28, 2011

(54) METHOD FOR HEATING THE INLET AIR OF A BIOMASS DRYER BY MEANS OF AN INTERMEDIATE CIRCUIT AND UTILIZING THE CIRCULATING HEATING LIQUID OF THE DRYER WHEN THE FACTORY PRODUCING LIQUID BIOFUELS IS INTEGRATED WITH ANOTHER FACTORY

(75) Inventor: Jorma KAUTTO, Vantaa (FI)

(73) Assignee: Vapo Oy, Jyvaskyla (FI)

(21) Appl. No.: 12/905,515

(22) Filed: Oct. 15, 2010

(30) Foreign Application Priority Data
Oct. 26, 2009 (FI) 20096097

(51) Int. Cl. F26B 23/00

(52) U.S. Cl. 432/29

(57) ABSTRACT

A method is disclosed for heating the drying air of a biomass dryer, such as the drying air used in a wire belt conveyor. An essential feature of the invention is that the heating of the drying air takes place with the help of a water-glycol mixture or other equivalent nonfreezing medium flowing in an intermediate circuit, whereby a plant producing biodiesel obtains thermal energy for drying from another nearby-located industrial plant such as a pulp or paper mill.

The invention relates to a method in accordance with the preamble of claim 1 for heating the drying air of a biomass dryer, such as the drying air used in a wire belt conveyor dryer in a situation where a factory that comprises a biomass drying step in the production of liquid biofuels like biodiesel receives the drying energy from another factory such as a pulp or paper mill. The invention also relates to the use of the liquid in accordance with claim 7.

In the art are known various embodiments used for heating the inlet air of a biomass dryer. Typically, the drying air is ambient air heated by means a heat exchanger.

The BtL (Biomass to Liquid) process releases a rather large amount of heat energy, chiefly in the form of saturated steam, that may be utilized in electric energy production and drying other types of extensively processed products such as paper. When a BtL installation is integrated with a pulp or paper mill, the cooperation generally provides access to a great amount of low-value warm waters at a temperature of, e.g., 40-100° C. that are useless in a pulp or paper mill. These water flows can be advantageously utilized in drying a biomass.

In prior-art publication FI20031586 is described a wire belt dryer process wherein the heat exchanger of the dryer utilizes warm waters received from pulp and paper mills. The temperature of the biomass drying air is typically less than 115° C., typically about 90-110° C. At higher temperatures wood chips begin to release substantial amounts of volatile compounds such as terpenes generally known as VOCs (Volatile Organic Compounds).

In the art are known plural different techniques for drying biomass, the most established of them being the use of a wire belt conveyor dryer. Typically, the wire belt of a conveyor dryer is maximally 6 m wide with a length of 60 m. The biomass is loaded onto the belt as an even layer. The thickness of the layer can be 150 mm, for instance. The belt is a fabric permeable to air, generally made of plastic or metallic material. In the drying process, a blower is adapted below the belt to generate a vacuum for sucking warm drying air through the biomass bed. When passing through the bed, the air becomes moist thus reducing the water content of the biomass.

In addition to those described above, in the art are known embodiments having the biomass bed divided at the end of the belt into two flows. In one embodiment, the biomass dried in the first pass is screened and the fines drying faster are separated from the coarse fraction. The coarse fraction is recycled onto the top surface of the biomass bed whereon it is dried further. The coarse fraction is removed from the surface of the bed at the delivery end of the belt.

As mentioned above, a wire belt conveyor generally accomplishes drying with the help of cold ambient air sucked by vacuum through heat exchangers. A disadvantage of this prior-art embodiment is that if water circulation is stopped during wintertime and the ambient temperature is below the freezing point of water, the water trapped in the heat exchanger will freeze. Freezing may result in damage and leakage in the heat exchangers. This problem has also been encountered in practice in process plants wherein biomass is being dried.

Now the method according to the invention offers a novel arrangement capable of avoiding the problems hampering the prior art. The essential features of the invention are crucial elements of the method and use thereof defined in the claims.

Resultingly, the arrangement according to the invention offers improved efficiency in the heating of the drying air used in a biomass dryer such as a wire belt conveyor dryer. More precisely, the invention is characterized by what is stated in the claims. The invention is particularly characterized by employing a water-glycol mixture or other nonfreezing medium in an intermediate circuit. In accordance with the above description, the invention is directed to a novel method for heating the drying air of a biomass dryer with the help of an intermediate circuit and use of a circulating medium employed therein in such a fashion that the plant producing biofuels is integrated with another industrial plant. This kind of an industrial plant is, e.g., a pulp or paper mill. The plant producing biofuels is, e.g., installations producing biodiesel or alcohols used as vehicle fuel.

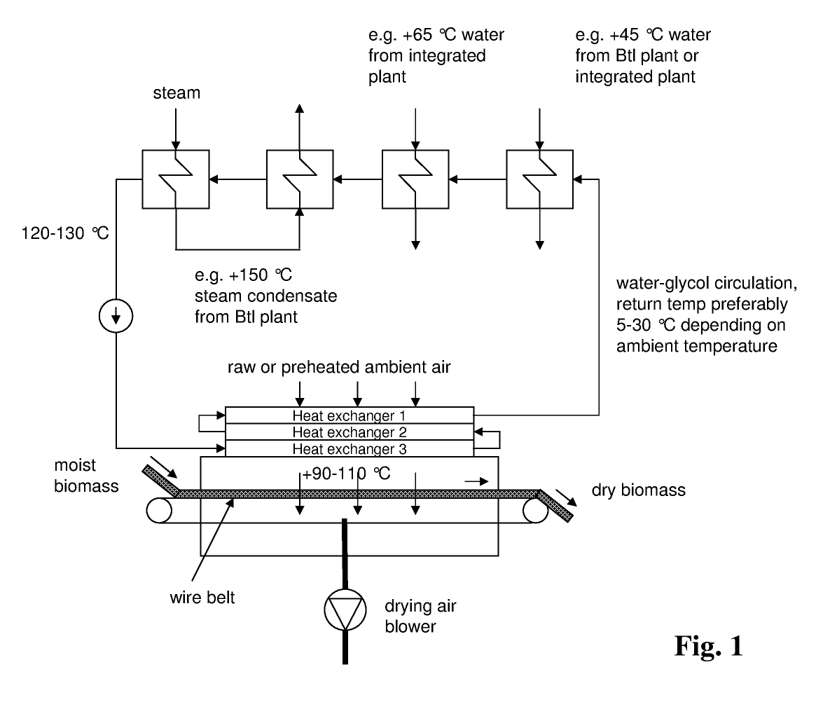

The invention is next described in more detail with the help of a preferred exemplifying embodiment by making reference to appended FIG. 1 in which drawing

FIG. 1 shows an embodiment implementing the method.

The invention is directed to a method for heating the drying air of a biomass dryer, such as the heating air used in a wire belt conveyor dryer. In accordance with FIG. 1, the invention is characterized by employing a water-glycol mixture or other nonfreezing medium such as nonfreezing alcohols in an intermediate circuit.

An essential feature of the invention is that it now permits heating the drying air under the most adverse conditions without the risk of freezing. To this end, the method accomplishes heating of dryer air with the help of heat exchangers heated with water-glycol mixtures in which the water/glycol ratio is about 50/50 or 60/40. A further essential feature is that the water-glycol circuit of the process is heated in a prioritized order. Most advantageously this occurs in such a fashion that in the first stage are utilized the waters of lower heat content such as those available from the integrated plant at a temperature of about +45° C. or equivalent cooling waters of the Btl process. In the second stage is utilized warm water available from the integrated pulp mill, such as the cooling water of a flue gas scrubber, for instance 65° C. Next, the water-glycol circulation can be heated by other available (pressurized) waters at a temperature of 65-150° C. Finally, the temperature of the water-glycol circulation is topped with the help of steam obtained from plant's own process or a boiler, whereby the condensation energy of the steam is recovered. Hence, the number of heat exchanger connected in series may vary depending on the type of available energy sources, a typical number of them being 4 to 6.

Topping in this context means that, after the basic energy for drying is obtained from warm waters, the supplementary energy can be obtained from steam generated in such an amount that the overall heat demand is satisfied. This means that the drying energy consumption is topped by steam that supplies the marginal heat demand. This terminology is conventionally used in the art of energy technology.

The efficiency of the method is further enhanced by collecting energy from multiple sources, whereby the water-glycol circuit is mounted close to the heat sources. This arrangement makes it possible to dry a biomass utilizing warm waters of lesser heat content at a temperature of about 40-100° C. which thereby are compatible with the requirements for biomass drying air temperature.

In the operation of a water-glycol circuit it is crucial to keep the pressure of the heating water circuits above that of the pressure of water-glycol circuit. In the case that a damage should occur in the heat exchangers, the leakage takes place from the heating water circuit to the water-glycol circuit. Resultingly, the return flows to, e.g., boiler circuits can be kept free from substances detrimental to their operation. Alternatively, the water-glycol circuit may contain tracer substances whose presence in the return water is monitored. In the case of a leakage, the location of the fault can be identified and repaired at earliest possible stage or the leaking heat exchanger may be disconnected.

To a person skilled in the art it is obvious that the invention is not limited by the above-described exemplary embodiments, but rather may be varied within the inventive spirit and scope of the appended claims.

1. A method for heating the drying air of a biomass dryer, such as the drying air used in a wire belt conveyor, wherein the method the heating of the drying air takes place with the help of a water-glycol mixture or other equivalent nonfreezing medium flowing in an intermediate circuit, said medium being heated by thermal energy obtained from another industrial plant integrated with a plant producing liquid biofuels.

2. The method of claim 1, wherein the method accomplishes dryer air heating with the help of heat exchangers heated with water-glycol mixtures in which the water/glycol ratio is about 50/50 or 60/40.

3. The method of claim 1, wherein the method the thermal energy to the intermediate circuit is collected from plural different sources and, when necessary, the water-glycol circulation is adapted in a close vicinity of the thermal energy sources.

4. The method of claim 1, wherein the method the water-glycol circuit of the process is heated in a given prioritized order in such a fashion that in the first stage are utilized the waters of lower heat content such as those available from the integrated plant at a temperature of about +45° C. or equivalent cooling waters of the Btl process, whereupon in the second stage is utilized warm water available from the integrated pulp mill, such as the cooling water of a flue gas scrubber, for instance.

5. The method of claim 1, wherein the method the temperature of the water-glycol circulation is topped with the help of steam or equivalent process heat source, particularly if warm waters are in a short supply, e.g., in wintertime.

6. The method of claim 1, wherein the method the water-glycol circuit is cooled by sea water, for instance, if the drying plant cannot receive all warm water.

7. Use of a water-glycol mixture or other equivalent nonfreezing medium in an intermediate circuit for heating the drying air of a biomass dryer such as a wire belt conveyor.

8. The use according to claim 7 for heating the inlet air of a biomass dryer with the help of an intermediate circuit whereby heating the inlet air of the dryer is accomplished with the help of heat exchangers utilizing water-glycol mixtures in which the water/glycol ratio is about 50/50 or 60/40.

9. The use according to claim 7 for heating the inlet air of a biomass dryer with the help of an intermediate circuit and the use of the liquid circulated therein in such a fashion that the plant producing biofuels is integrated with another industrial plant.

10. The use according to claim 7 for heating the inlet air of a biomass dryer whereby the plant producing biofuels is, e.g., an installation producing biodiesel or alcohols used as vehicle fuels and the industrial plant integrated therewith is, e.g., a pulp or paper mill.

11. The method of claim 2, wherein the method the thermal energy to the intermediate circuit is collected from plural different sources and, when necessary, the water-glycol circulation is adapted in a close vicinity of the thermal energy sources.

12. The method of claim 2, wherein the method the water-glycol circuit of the process is heated in a given prioritized order in such a fashion that in the first stage are utilized the waters of lower heat content such as those available from the integrated plant at a temperature of about +45° C. or equivalent cooling waters of the Btl process, whereupon in the second stage is utilized warm water available from the integrated pulp mill, such as the cooling water of a flue gas scrubber, for instance.

13. The method of claim 3, wherein the method the water-glycol circuit of the process is heated in a given prioritized order in such a fashion that in the first stage are utilized the waters of lower heat content such as those available from the integrated plant at a temperature of about +45° C. or equivalent cooling waters of the Btl process, whereupon in the second stage is utilized warm water available from the integrated pulp mill, such as the cooling water of a flue gas scrubber, for instance.

14. The method of claim 2, wherein the method the temperature of the water-glycol circulation is topped with the help of steam or equivalent process heat source, particularly if waters are in a short supply, e.g., in wintertime.

15. The method of claim 3, wherein the method the temperature of the water-glycol circulation is topped with the help of steam or equivalent process heat source, particularly if waters are in a short supply, e.g., in wintertime.

16. The method of claim 4, wherein the method the temperature of the water-glycol circulation is topped with the help of steam or equivalent process heat source, particularly if warm waters are in a short supply, e.g., in wintertime.

17. The method of claim 2, wherein the method the water-glycol circuit is cooled by sea water, for instance, if the drying plant cannot receive all warm water.

18. The method of claim 3, wherein the method the water-glycol circuit is cooled by sea water, for instance, if the drying plant cannot receive all warm water.

19. The method of claim 4, wherein the method the water-glycol circuit is cooled by sea water, for instance, if the drying plant cannot receive all warm water.

20. The method of claim 5, wherein the method the water-glycol circuit is cooled by sea water, for instance, if the drying plant cannot receive all warm water.
